(19) United States
(12) Patent Application Publication
(10) Pub. No.: US 2021/0333619 A1
(43) Pub. Date: Oct. 28, 2021

(54) SUBSTRATE, LCD PANEL, AND MANUFACTURING METHOD OF SUBSTRATE

(71) Applicant: TCL CHINA STAR OPTOELECTRONICS TECHNOLOGY CO., LTD., Shenzhen (CN)

(72) Inventors: Chunqiu YAN, Shenzhen (CN); Yuan SHAO, Shenzhen (CN)

(73) Assignee: TCL CHINA STAR OPTOELECTRONICS TECHNOLOGY CO., LTD., Shenzhen (CN)

(21) Appl. No.: 16/626,362

(22) PCT Filed: Dec. 19, 2019
(86) PCT No.: PCT/CN2019/126593

§ 371 Date: Dec. 24, 2019

(30) Foreign Application Priority Data
Nov. 18, 2019 (CN) 201911129707.1

(51) Int. Cl. G02F 1/1335; G02F 1/1333; G02F 1/1339; G02F 1/1343

(52) U.S. Cl. CPC G02F 1/133512; G02F 1/133516; G02F 1/134309; G02F 1/13394; G02F 1/133357

(57) ABSTRACT

The present invention provides a substrate, a liquid crystal display panel, and a manufacturing method of the substrate. The substrate includes a base; a color resist layer arranged on the substrate and having a patterned black matrix; and a planarization layer arranged on the color resist layer and patterned to form support blocking walls. A material of the support blocking walls replaces an original material of the planarization layer. The support blocking wall provides a planarization effect and a support effect. Therefore, costs for manufacturing the planarization layer is reduced, and a manufacturing process is improved.

This application claims priority to Chinese patent application no. 201911129707.1, entitled “Substrate, LCD Panel, and Manufacturing Method of Substrate”, filed on Nov. 18, 2019, the entire contents of which are incorporated by reference in this application.

### 1. FIELD OF THE DISCLOSURE

The present disclosure relates to a field of display technology and in particular, to a substrate, an LCD panel, and a manufacturing method of substrate.

### 2. DESCRIPTION OF THE RELATED ART

Liquid crystal displays (LCDs) are the most widely used display product on the market. Its manufacturing technology is very mature with high production yields, relatively low production costs, and high market acceptance. Most of the LCDs on the market are backlit LCD devices, which include an LCD panel and a backlight module. Generally, an LCD panel consists of a color filter substrate, an array substrate, liquid crystals sandwiched between the color filter substrate and the array substrate, and a sealant. The color filter substrate mainly includes a color filter layer for forming colored light through a color resist unit, a black matrix for preventing light leakage at an edge of a pixel, and a spacer for maintaining a cell thickness.

In the substrate of the LCD, a planarization layer is usually disposed to improve flatness and reduce usage of the liquid crystals. However, in conventional techniques, it is costly to manufacture the planarization layer, and a useless electrode layer under the spacer in the substrate of the LCD causes a parasitic capacitance which is harmful to the LCD.

In summary, during a manufacturing process of a conventional substrate, a planarization layer is usually disposed to improve flatness and reduce the usage of liquid crystals. Because it is costly to manufacture the planarization layer, the production costs of an LCD are high. Therefore, it is necessary to provide a new substrate, an LCD panel, and a manufacturing method of the substrate to solve this problem.

### SUMMARY

The present application provides a substrate, an LCD panel, and a manufacturing method of the substrate to solve a problem that it is costly to manufacture a planarization layer through conventional techniques, and therefore product costs are greatly increased.

Accordingly, the present application provides a substrate, comprising:

a base;

a color resist layer arranged on the substrate and comprising a patterned black matrix; and

a planarization layer disposed on the color resist layer and patterned to form a plurality of support blocking walls.

According to one embodiment of the present application, the substrate comprises an electrode layer, and the electrode layer is disposed on the planarization layer and arranged between the support blocking walls.

According to one embodiment of the present application, a thickness of the electrode layer is less than a height of the support blocking wall.

According to one embodiment of the present application, the electrode layer is made of one or more combinations of polyethylene dioxythiophene and polystyrene sulfonate.

According to one embodiment of the present application, the electrode layer is made of silver nanowire.

According to one embodiment of the present application, a thickness of the electrode layer is in a range from 20 nanometers (nm) to 500 nm.

According to one embodiment of the present application, the planarization layer is made of a hydrophobic material.

According to one embodiment of the present application, the color resist layer further comprises a chromatic color resist, and the chromatic color resist is arranged in a gap of the black matrix.

According to one embodiment of the present application, a region of the planarization layer excluding the support blocking walls has a thickness ranging from 0.1 micrometer (μm) to 2 μm.

According to one embodiment of the present application, a height of the support blocking wall is in a range from 2 μm to 10 μm.

Accordingly, the present application further provides a liquid crystal display (LCD) panel, comprising:

a first substrate;

a second substrate and the first substrate assembled to each other; and

a liquid crystal layer filled between the first substrate and the second substrate;

wherein the first substrate comprises:
a base;
a color resist layer arranged on the base and comprising a patterned black matrix; and

a planarization layer disposed on the color resist layer and patterned to form a plurality of support blocking walls.

According to one embodiment of the present application, the substrate comprises an electrode layer, and the electrode layer is disposed on the planarization layer and arranged between the support blocking walls.

According to one embodiment of the present application, a thickness of the electrode layer is less than a height of the support blocking wall.

According to one embodiment of the present application, the electrode layer is made of one or more combinations of polyethylene dioxythiophene and polystyrene sulfonate.

According to one embodiment of the present application, a thickness of the electrode layer is in a range from 20 nanometers (nm) to 500 nm.

According to one embodiment of the present application, the planarization layer is made of a hydrophobic material.

According to one embodiment of the present application, the color resist layer further comprises a chromatic color resist, and the chromatic color resist is arranged in a gap of the black matrix.

According to one embodiment of the present application, a region of the planarization layer excluding the support blocking walls has a thickness ranging from 0.1 micrometer (μm) to 2 μm.

According to one embodiment of the present application, a height of the support blocking wall is in a range from 2 μm to 10 μm.

Accordingly, the present application further provides a manufacturing method of a substrate, comprising following steps:
providing a base;
forming a color resist layer on the substrate, the color resist layer comprising a patterned black matrix;
forming a planarization layer on the color resist layer; and
patterning the planarization layer to form a plurality of support blocking walls.

The present application provides a substrate, an LCD panel, and a manufacturing method of a substrate. In the substrate, a material of support blocking walls replaces a material of a conventional planarization layer. The support blocking walls can achieve planarization and provide support at the same time, which not only reduces the costs of the planarization layer, but also improves a manufacturing process and increases productivity.

### BRIEF DESCRIPTION OF THE DRAWINGS

In order to more clearly illustrate the embodiments of the present disclosure or related art, figures which will be described in the embodiments are briefly introduced hereinafter. It is obvious that the drawings are merely for the purposes of illustrating some embodiments of the present disclosure, a person having ordinary skill in this field can obtain other figures according to these figures without an inventive work or paying the premise.

FIG. 1 is a schematic structural view illustrating a substrate according to one embodiment of the present application;

FIG. 2 is another schematic structural view illustrating the substrate according to one embodiment of the present application;

FIG. 3 is a process flow diagram illustrating a manufacturing method of the substrate according to one embodiment of the present application;

FIG. 4A to 4D illustrate steps in the manufacturing method of the substrate according to one embodiment of the present application;

FIG. 5 is a process flow diagram illustrating a manufacturing method of the substrate having another structure according to one embodiment of the present application; and

FIGS. 6A to 6D illustrate steps in the manufacturing method of the substrate having another structure according to one embodiment of the present application.

### DETAILED DESCRIPTION OF THE EMBODIMENTS

The present application provides a substrate, a liquid crystal display (LCD) panel, and a manufacturing method of the substrate. Technical solutions of the present invention will be clearly and completely described below with reference to specific embodiments and the accompanying drawings. It is apparent that the embodiments are for illustrative purposes only and not intended to limit the present invention.

In the present disclosure, terms, such as “above”, “below”, “left”, “right”, “front”, “rear”, “inner”, “outer”, “lateral”, should be construed to refer to the orientation based on the accompanying drawings. These terms are merely for ease of description and not intended to limit the present application. Terms such as “first” and “second” are used for purposes of description and are not intended to indicate or imply relative importance or significance or impliedly indicate the quantity of the technical features referred to. Thus, the feature defined with “first” and “second” may explicitly or implicitly indicate inclusion of one or more of this feature.

COA (color filter on array) technology is a technology for forming a color filter layer on an array substrate. Compared with conventional liquid crystal display (LCD) technology, a black matrix, spacers, and color filters are all arranged on one side of the array substrate. This avoids errors due to alignment in an alignment process, and due to displacement caused by panel bending in curved display technology. More importantly, one material and one manufacturing step can be saved, so manufacture time (tact time) is reduced, and production costs are lowered.

At the same time, in order to improve flatness of a COA substrate, conventional technology covers a color resist layer of the COA substrate with an organic planarization layer and then forms a spacer and a black matrix on the organic planarization layer.

In the conventional substrate, it is costly to manufacture the planarization layer, and a useless electrode layer is disposed under the spacer in the substrate of an LCD and causes a parasitic capacitance that is harmful to the LCD. In order to solve the above problem, a technical solution of the present application is to provide a substrate, replace an original material of the planarization layer with a material of a support blocking wall, and form an electrode layer after the support blocking wall is formed by patterning. Accordingly, costs for manufacturing the planarization layer are reduced, and there is no useless electrode layer under the support blocking wall. The application is described in detail below with reference to the accompanying drawings.

### First Embodiment

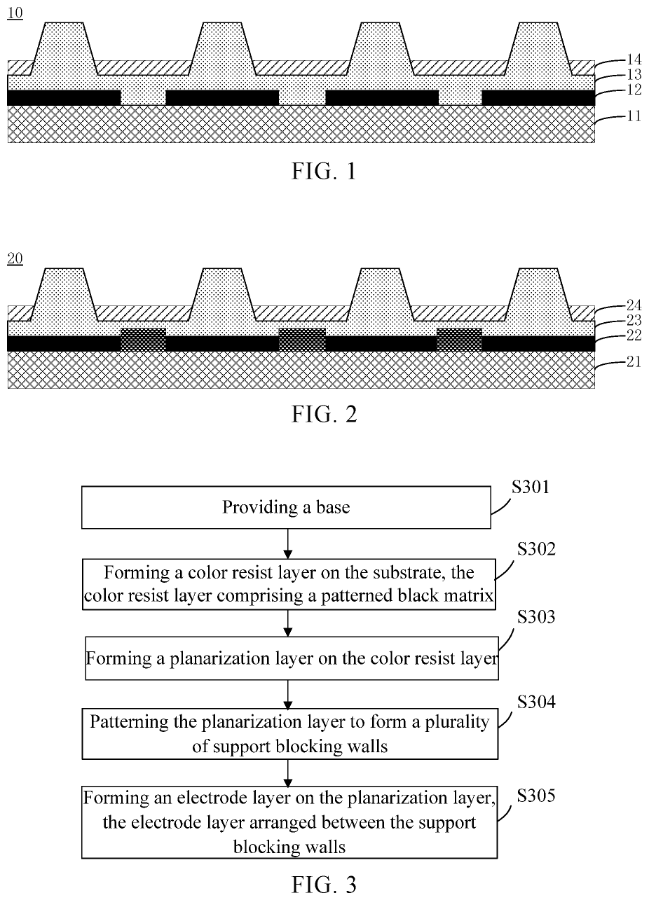

Referring to FIG. 1, it is a schematic structural view illustrating a substrate according to one embodiment of the present application. The drawing shows components of the present application and a positional relationship thereof. As shown in FIG. 1, the substrate 10 comprises a base 11, a color resist layer 12, a planarization layer 13, and an electrode layer 14. The color resist layer 12 is arranged on the base 11 and comprises a patterned black matrix. The planarization layer 13 is disposed on the color resist layer 12 and is patterned to form a plurality of support blocking walls. The electrode layer 14 is disposed on the planarization layer 13 and arranged between the support blocking walls.

In the above embodiment, the electrode layer 14 is made of one or more combinations of polyethylene dioxythiophene and polystyrene sulfonate, or the electrode layer 14 is made of silver nanowire. The planarization layer 13 is made of a hydrophobic material.

In the above embodiment, a region of the planarization layer 13 excluding the support blocking walls has a thickness ranging from 0.1 micrometer (μm) to 2 μm, and the thickness is higher than a height of the black matrix. A height of the support blocking wall is in a range from 2 μm to 10 μm. A thickness of the electrode layer 14 is less than a height of the support blocking wall, and a thickness of the electrode layer 14 is in a range from 20 nanometers (nm) to 500 nm.

In detail, the electrode layer 14 is made of one or more combinations of polyethylene dioxythiophene and polystyrene sulfonate, or the electrode layer 14 is made of silver nanowire. The material of the electrode layer 14 is an aqueous conductive paste, and the planarization layer 13 is made of the hydrophobic material. When the hydrophobic material is in contact with a solution, the hydrophobic material has a large contact angle, thereby preventing the electrode layer from being formed in a region of the support blocking wall in the planarization layer 13.

### Second Embodiment

Referring to FIG. 2, it is another schematic structural view illustrating the substrate according to one embodiment of the present application. The drawing illustrates components of the present application and a positional relationship thereof. As shown in FIG. 2, the substrate 20 comprises a base 21, a color resist layer 22, a planarization layer 23, and an electrode layer 24. The color resist layer 22 is arranged on the base 21 and comprises a patterned black matrix and a chromatic color resist in a gap of the black matrix. The planarization layer 23 is disposed on the color resist layer 22 and is patterned to form a plurality of support blocking walls. The electrode layer 24 is disposed on the planarization layer 23 and arranged between the support blocking walls.

In the above embodiment, the electrode layer 24 is made of one or more combinations of polyethylene dioxythiophene and polystyrene sulfonate. The planarization layer 23 is made of a hydrophobic material.

In the above embodiment, a region of the planarization layer 23 excluding the support blocking walls has a thickness ranging from 0.1 micrometer (μm) to 2 μm. A height of the support blocking wall is in a range from 2 μm to 10 μm. A thickness of the electrode layer 24 is less than a height of the support blocking wall, and a thickness of the electrode layer 24 is in a range from 20 nanometers (nm) to 500 nm.

In detail, the electrode layer 24 is made of one or more combinations of polyethylene dioxythiophene and polystyrene sulfonate, or the electrode layer is made of silver nanowire. The material is an aqueous conductive paste, and the planarization layer 23 is made of the hydrophobic material. When the hydrophobic material is in contact with a solution, the hydrophobic material has a large contact angle, thereby preventing the electrode layer 24 from being formed in a region of the support blocking wall in the planarization layer 23.

The present application further provides a liquid crystal display (LCD) panel. The LCD panel comprises a first substrate and a second substrate. The first substrate and the second substrate are assembled to each other. The first substrate is the substrate described in the first embodiment or the second embodiment. In addition, the LCD panel further comprises a liquid crystal layer filled between the first substrate and the second substrate.

Unlike the conventional technology, the substrate of the present embodiment uses a material of the support blocking wall to replace an original material of the planarization layer, and the electrode layer is formed after the support blocking layer is formed by patterning. As a result, costs for manufacturing the planarization layer are lowered. Moreover, the support blocking wall made of the hydrophobic material has a large contact angle when contacting a solution, so that there is no useless electrode layer under the support blocking wall, thereby avoiding a parasitic capacitance that is harmful to the LCD panel.

Referring to FIG. 3, it is a process flow diagram illustrating a manufacturing method of a substrate according to one embodiment of the present application. The manufacturing method comprises following steps:

step S301: providing a base;

step S302: forming a color resist layer on the substrate, the color resist layer comprising a patterned black matrix;

step S303: forming a planarization layer on the color resist layer;

step S304: patterning the planarization layer to form a plurality of support blocking walls; and

step S305: forming an electrode layer on the planarization layer, the electrode layer arranged between the support blocking walls.

A region of the planarization layer excluding the support blocking walls has a thickness ranging from 0.1 micrometer (μm) to 2 μm. The planarization layer is made of a hydrophobic material. The hydrophobic material can ensure that no electrode layer is formed in a region of the support blocking wall in the subsequent manufacturing steps, thereby avoiding a parasitic capacitance that is harmful to an LCD panel.

In detail, in step S304, a halftone mask method is used to pattern the planarization layer. The halftone mask method performs an exposure step by using gratings which allows partial light to pass through, and adjusts an amount of light passing through according to a desired height difference of the planarization layer, so that the photoresist can be incompletely exposed. The halftone mask method combines traditional two exposure steps into one, which saves one exposure step, shortens a production cycle, improves a throughput, and reduces production costs.

Furthermore, an inkjet printing method is simple, needs low manufacturing costs, and has easy to use equipment. Also, a slit coating method has high coating uniformity, a wide range of viscosity for coating, and a fast coating speed. Therefore, in step S305, the inkjet printing method or the slit coating method is used instead of using a conventional vapor deposition method for forming the electrode layer between the support blocking walls, so as to reduce manufacturing time, reduce costs, and form the electrode layer of higher uniformity.

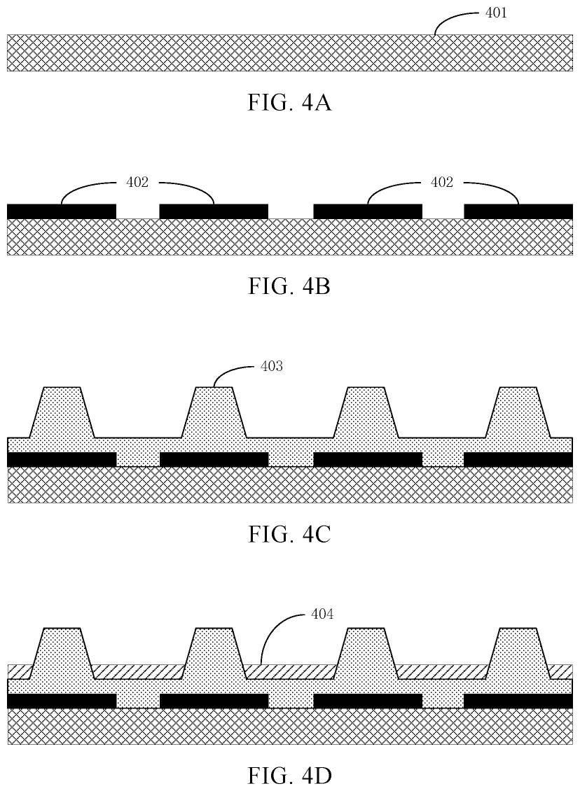

FIGS. 4A to 4D illustrate steps in the manufacturing method of the substrate according to one embodiment of the present application. First, a base 401 is provided. The base 401 is made of an inorganic material such as polyimide or glass, and then a color resist layer 402 is formed on the base 401, wherein the color resist layer 402 comprises a patterned black matrix. After that, a planarization layer 403 is formed on the color resist layer 402. The planarization layer 403 is made of a hydrophobic material, and the planarization layer 403 is patterned to form support blocking walls. Finally, an electrode layer 404 is formed on the planarization layer 403, and the electrode layer 404 is arranged between the support blocking walls.

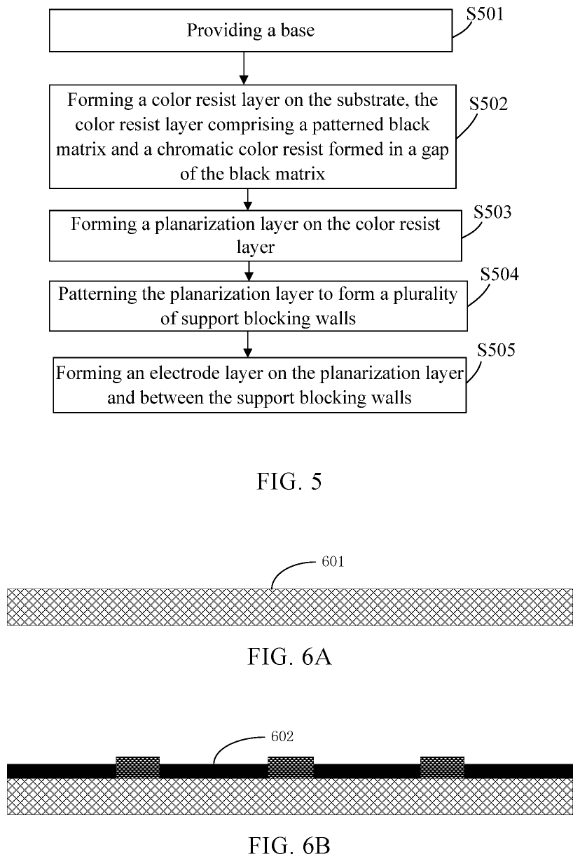

Referring to FIG. 5, it is a process flow diagram illustrating a manufacturing method of a substrate having another structure according to one embodiment of the present application. The manufacturing method comprises following steps:

step 501: providing a base;

step 502: forming a color resist layer on the substrate, the color resist layer comprising a patterned black matrix and a chromatic color resist formed in a gap of the black matrix;

step 503: forming a planarization layer on the color resist layer;

step 504: patterning the planarization layer to form a plurality of support blocking walls;

and

step 505: forming an electrode layer on the planarization layer and between the support blocking walls.

The planarization layer is made of a hydrophobic material. The hydrophobic material can ensure that no electrode layer is formed in a region of the support blocking wall in the subsequent manufacturing steps, thereby avoiding a parasitic capacitance that is harmful to an LCD panel.

In detail, in step S504, a halftone mask method is used to pattern the planarization layer. The halftone mask method performs an exposure step by using gratings which allows partial light to pass through, and adjusts an amount of light passing through according to a desired height difference of the planarization layer, so that a photoresist can be incompletely exposed. The half mask method combines traditional two exposure steps into one, which saves one exposure step, shortens a production cycle, improves a throughput, and reduces production costs.

Furthermore, an inkjet printing method is simple, needs low manufacturing costs, and has easy to use equipment. Also, a slit coating method has high coating uniformity, a wide range of viscosity for coating, and a fast coating speed. Therefore, in step S505, the inkjet printing method or the slit coating method is used instead of using a conventional vapor deposition method for forming the electrode layer between the support blocking walls, so as to reduce manufacturing time, reduce costs, and form the electrode layer of higher uniformity.

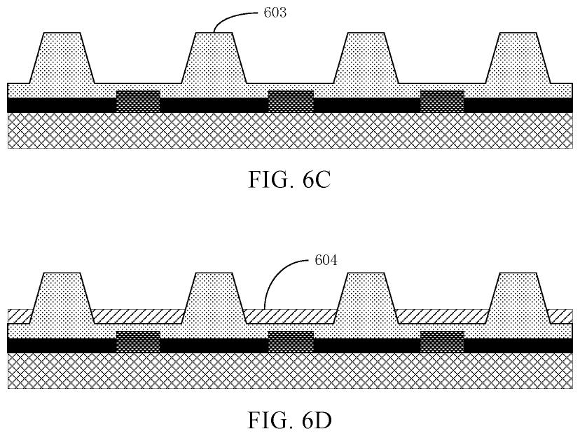

FIGS. 6A to 6D illustrate steps in the manufacturing method of the substrate having another structure according to one embodiment of the present application. First, a base 601 is provided. The base 601 is made of an inorganic material such as polyimide or glass, and then a color resist layer 602 is formed on the base 601, wherein the color resist layer 602 comprises a patterned black matrix and a chromatic color resist in a gap of the black matrix. After that, a planarization layer 603 is formed on the color resist layer 602. The planarization layer 603 is made of a hydrophobic material, and the planarization layer 603 is patterned to form support blocking walls. Finally, an electrode layer 604 is formed on the planarization layer 603, and the electrode layer 604 is arranged between the support blocking walls.

Different from the conventional technology, the manufacturing method of the substrate of the present embodiment uses a material of the support blocking wall to replace an original material of the planarization layer, and the electrode layer is formed after the support blocking layer is formed by patterning. As a result, costs for manufacturing the planarization layer are lowered. Moreover, the support blocking wall made of the hydrophobic material has a large contact angle when contacting a solution, so that there is no useless electrode layer under the support blocking wall, thereby avoiding a parasitic capacitance that is harmful to the LCD panel.

In conclusion, although the present application has been disclosed above with preferable embodiments, the above-mentioned embodiments are not intended to limit the present application. Those skilled in the art can make various modifications without departing from the spirit and scope of the present application. Thus, the protection scope of this application is defined by the appended claims.

What is claimed is:

1. A substrate, comprising:
a base;
a color resist layer arranged on the substrate and comprising a patterned black matrix; and
a planarization layer disposed on the color resist layer and patterned to form a plurality of support blocking walls.

2. The substrate according to claim 1, wherein the substrate comprises an electrode layer, and the electrode layer is disposed on the planarization layer and arranged between the support blocking walls.

3. The substrate according to claim 2, wherein a thickness of the electrode layer is less than a height of the support blocking wall.

4. The substrate according to claim 2, wherein the electrode layer is made of one or more combinations of polyethylene dioxythiophene and polystyrene sulfonate.

5. The substrate according to claim 2, wherein the electrode layer is made of silver nanowire.

6. The substrate according to claim 4, wherein a thickness of the electrode layer is in a range from 20 nanometers (nm) to 500 nm.

7. The substrate according to claim 4, wherein the planarization layer is made of a hydrophobic material.

8. The substrate according to claim 1, wherein the color resist layer further comprises a chromatic color resist, and the chromatic color resist is arranged in a gap of the black matrix.

9. The substrate according to claim 1, wherein a region of the planarization layer excluding the support blocking walls has a thickness ranging from 0.1 micrometer (μm) to 2 μm.

10. The substrate according to claim 9, wherein a height of the support blocking wall is in a range from 2 μm to 10 μm.

11. A liquid crystal display (LCD) panel, comprising:
a first substrate;
a second substrate and the first substrate assembled to each other; and
a liquid crystal layer filled between the first substrate and the second substrate;
wherein the first substrate comprises:
a base;
a color resist layer arranged on the base and comprising a patterned black matrix; and
a planarization layer disposed on the color resist layer and patterned to form a plurality of support blocking walls.

12. The LCD panel according to claim 11, wherein the substrate comprises an electrode layer, and the electrode layer is disposed on the planarization layer and arranged between adjacent support blocking walls.

13. The LCD panel according to claim 12, wherein a thickness of the electrode layer is less than a height of the support blocking wall.

14. The LCD panel according to claim 12, wherein the electrode layer is made of one or more combinations of polyethylene dioxythiophene and polystyrene sulfonate.

15. The LCD panel according to claim 14, wherein a thickness of the electrode layer is in a range from 20 nanometers (nm) to 500 nm.

16. The LCD panel according to claim 14, wherein the planarization layer is made of a hydrophobic material.

17. The LCD panel according to claim 11, wherein the color resist layer further comprises a chromatic color resist, and the chromatic color resist is arranged in a gap of the black matrix.

18. The LCD panel according to claim 11, wherein a region of the planarization layer excluding the support blocking walls has a thickness ranging from 0.1 micrometer (μm) to 2 μm.

19. The LCD panel according to claim 11, wherein a height of the support blocking wall is in a range from 2 μm to 10 μm.

20. A manufacturing method of a substrate, comprising following steps:
providing a base;
forming a color resist layer on the substrate, the color resist layer comprising a patterned black matrix;
forming a planarization layer on the color resist layer; and
patterning the planarization layer to form a plurality of support blocking walls.
